(19) United States
(12) Patent Application Publication
(10) Pub. No.: US 2009/0301252 A1
(43) Pub. Date: Dec. 10, 2009

(54) Bicycle brake lever

(76) Inventor: Chia-Wei Hsu, Fusing Hsiang (TW)

Correspondence Address: BACON & THOMAS, PLLC, 625 SLATERS LANE, FOURTH FLOOR, ALEXANDRIA, VA, 22314-1176, US

(21) Appl. No.: 12/155,588

(22) Filed: Jun. 6, 2008

(51) Int. Cl. B62K 21/16

(52) U.S. Cl. 74/489

(57) ABSTRACT

A bicycle brake lever has a body, a lever and an adjusting device. The body has a mounting bracket and a pivot segment. The pivot segment has two pivot panels and multiple detents. The lever is connected to the body and has a pivot end and a lever arm. The pivot end is mounted pivotally on the pivot segment using a pivot pin and has a protruding rib. The adjusting device is connected to the body, engages the lever and has a switch, a positioning element and an engaging block. The switch is mounted on the pivot segment. The positioning element is mounted in the switch and engages the detents of the pivot panels. The engaging block is connected to and moved by the switch and engages the rib of the lever to allow adjustment of the lever relative to a handlebar.

### BACKGROUND OF THE INVENTION

1. Field of the Invention

The present invention relates to a bicycle brake lever, and more particularly to a bicycle brake lever that is mounted on a handlebar of a bicycle and allows adjustment of an included angle between the bicycle brake lever and the handlebar.

2. Description of Related Art

A conventional bicycle brake system is mounted on a bicycle having a front wheel, a rear wheel and a handlebar, and has a brake lever, a brake and a brake cable. The brake lever is mounted around the handlebar of the bicycle. The brake is mounted on the bicycle near the front wheel or the rear wheel. The brake cable is mounted between the brake lever and the brake. A user moves the brake lever, normally by pulling, to move the brake cable and actuate the brake to make the bicycle slow down or stop.

However, an included angle between the brake lever and the handlebar is constant before pressing the brake lever, and children or people with small hands cannot pull the brake lever easily and this hinders braking effectiveness of the conventional brake system and may cause accidents, especially in traffic.

Furthermore, when the user rides the bicycle down a gradient, the brake lever is held for a long time to slow the bicycle and this is inconvenient and laborious.

To overcome the shortcomings, the present invention tends to provide a bicycle brake lever to mitigate or obviate the aforementioned problems.

### SUMMARY OF THE INVENTION

The main objective of the present invention is to provide a bicycle brake lever that is mounted on a handlebar of a bicycle and allows adjustment of an included angle between the bicycle brake lever and the handlebar.

The bicycle brake lever in accordance with the present invention is implemented on a bicycle having a handlebar and a brake cable and has a body, a lever and an adjusting device. The body is mounted on the handlebar of the bicycle and has a mounting bracket and a pivot segment. The pivot segment is formed with the mounting bracket and has two pivot panels and multiple detents. The lever is pivotally connected to the body and has a pivot end and a lever arm. The pivot end is connected to the pivot using a pivot pin and has a rib. The adjusting device is connected to the body and engages the lever and has a switch, a positioning element and an engaging block. The switch is rotatably mounted on the pivot segment. The positioning element is mounted in the switch and selectively engages the detents of the pivot panels. The engaging block is connected to and moved by the switch, and engages the rib of the lever to allow adjustment of the lever relative to the handlebar.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a bicycle brake lever in accordance with the present invention mounted on a handlebar of a bicycle;

FIG. 2 is a perspective view of the bicycle brake lever in FIG. 1;

FIG. 3 is an exploded perspective view of the bicycle brake lever in FIG. 2;

FIG. 4 is a top view in partial section of the bicycle brake lever in FIG. 1;

FIG. 5 is a side view in partial section of the bicycle brake lever along line 5-5 in FIG. 4; and

FIGS. 6 to 9 are operational top views in partial section of the bicycle brake lever in FIG. 1.

### DETAILED DESCRIPTION OF THE PREFERRED EMBODIMENT

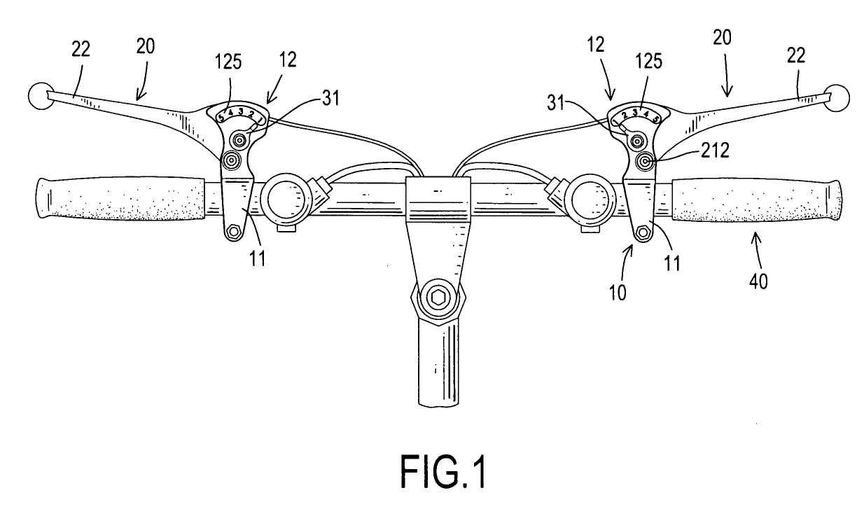

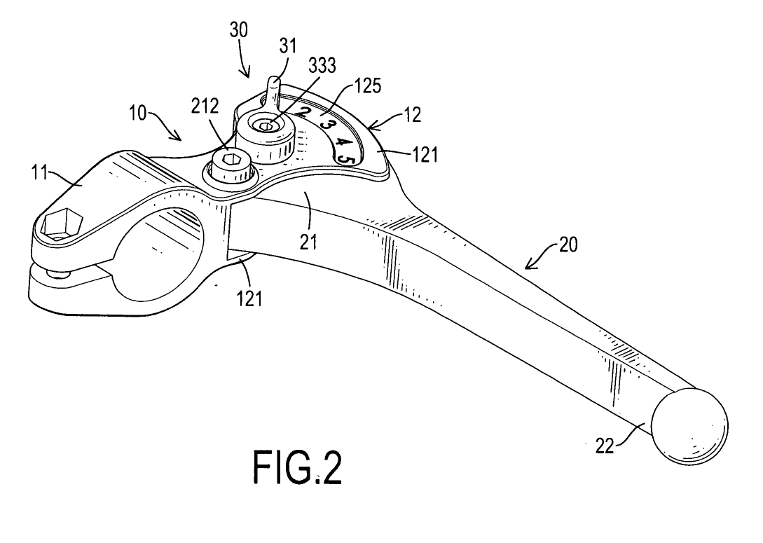

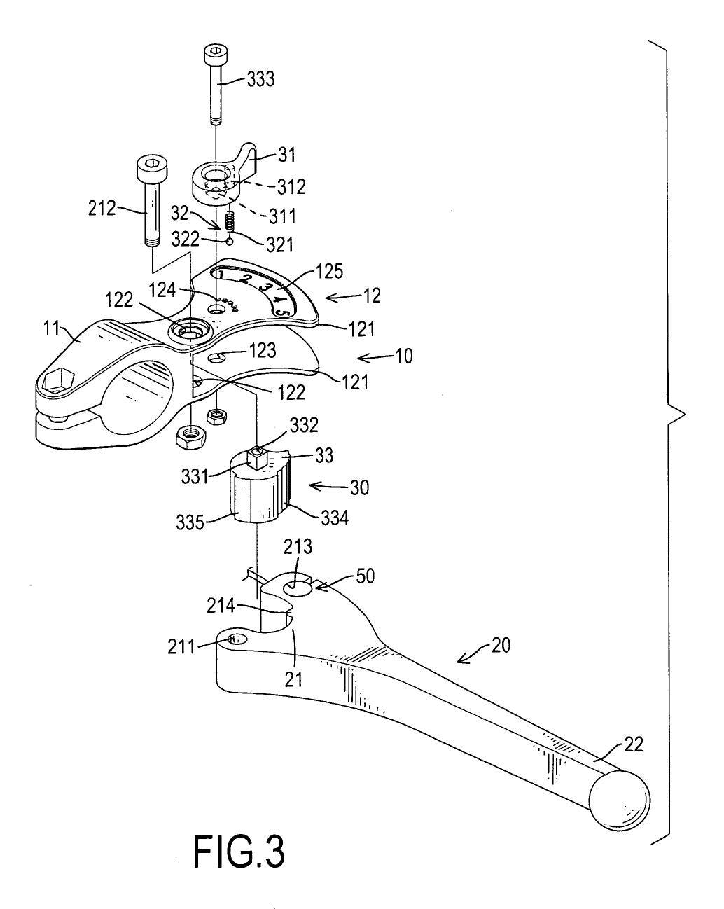

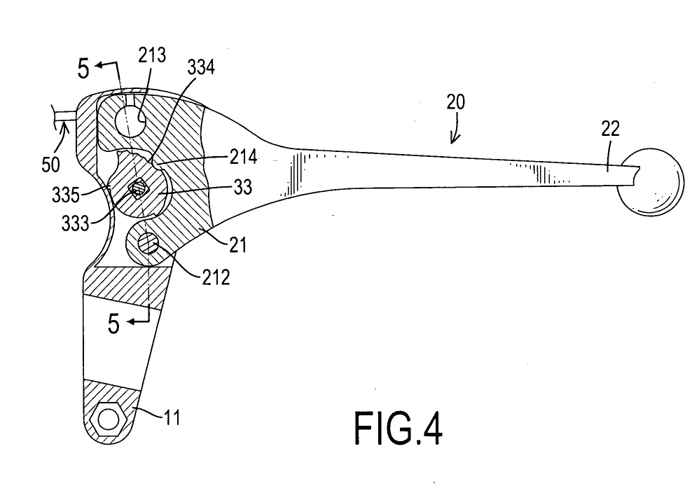

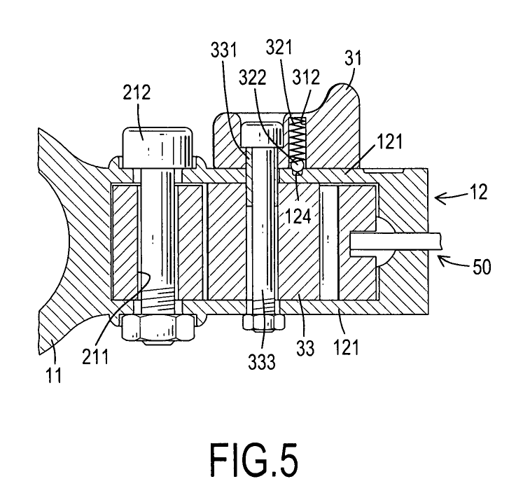

With reference to FIGS. 1 to 5, a bicycle brake lever is implemented on a bicycle having a handlebar (40) and a brake cable (50) and comprises a body (10), a lever (20) and an adjusting device (30).

The body (10) is mounted on the handlebar (40) of the bicycle and has a mounting end, a connecting end, a mounting bracket (11) and a pivot segment (12).

The mounting bracket (11) may be C-shaped, is defined in the mounting end of the body (10) and is mounted around the handlebar (40) of the bicycle.

The pivot segment (12) is defined in the connecting end of the body (10), is formed with the mounting bracket (11) and has two pivot panels (121), multiple detents (124) and an indicator board (125).

The pivot panels (121) are formed with the body (10) parallel to each other and each pivot panel (121) has a pivot hole (122) and a connecting hole (123). The pivot holes (122) are formed through the pivot panels (121) near the mounting bracket (11) and align with each other. The connecting holes (123) are formed through the pivot panels (121) near the pivot holes (122) opposite to the mounting bracket (11) and align with each other.

The detents (124) of the pivot segment (12) are formed through one of the pivot panels (121), may be in an arc, around the connecting hole (123).

The indicator board (125) is formed on the pivot panel (121) having the detents (124) and radially align with the connecting hole (123) through the detents (124).

The lever (20) is pivotally connected to the body (10) and has a pivot end (21) and a lever arm (22).

The pivot end (21) of the lever (20) may be Y-Shaped, is pivotally connected to the pivot segment (12) of the body (10) and has an internal surface, a through hole (211), a pivot pin (212), a cable hole (213) and a rib (214). The through hole (211) is formed through the pivot end (21) and aligns with the pivot holes (122) of the pivot panels (121). The pivot pin (212) is mounted in the pivot holes (122) of the pivot panels (121) and the through hole (211) of the pivot end (21) of the lever (20) to connect the lever (20) with the body (10). The cable hole (213) is formed through the pivot end (21) of the lever (20) opposite to the through hole (211) between the pivot panels (121) and is connected to the brake cable (50) of the bicycle. The rib (214) is formed on and protrudes from the internal surface of the pivot end (21) of the lever (20) between the through hole (211) and the cable hole (213).

The lever arm (22) is formed on the pivot end (21) so a user can press the lever arm (22) of the lever (20) to pull the brake cable (50) of the bicycle.

The adjusting device (30) is connected to the body (10) and engages the lever (20) and has a switch (31), a positioning element (32) and an engaging block (33).

The switch (31) is rotatably mounted on the pivot segment (12) of the body (10) and has a bottom, a mounting hole (311) and a mounting recess (312). The bottom of the switch (31) abuts the pivot panel (121) having the detents (124). The mounting hole (311) is polygonal, is formed through the bottom of the switch (31) and aligns with the connecting holes (123) of the pivot panels (121). The mounting recess (312) is formed in the bottom of the switch (31) and selectively communicates with the detents (124).

The positioning element (32) is mounted in the switch (31), engages the pivot panel (121) having the detents (124) and has a spring (321) and a ball (322). The spring (321) is mounted in the mounting recess (312) of the switch (31). The ball (322) is mounted in the mounting recess (312) of the switch (31), selectively engages the detents (124) in the pivot panel (121) to hold the switch (31) in place.

The engaging block (33) is connected to the switch (31) between the pivot panels (121), engages the pivot end (21) of the lever (20) and has a top, a sidewall, a switch mount (331), an inserting hole (332), a mounting shaft (333), multiple engaging recesses (334) and at least one resisting protrusion (335).

The switch mount (331) is formed on and protrudes from the top of the engaging block (33), corresponds to and is mounted in the mounting hole (311) of the switch (31) via the corresponding connecting hole (123).

The inserting hole (332) is formed through the switch mount (331) and the engaging block (33) and aligns with the mounting hole (311) of the switch (31) and the connecting holes (123) of the pivot panels (121).

The mounting shaft (333) is mounted in the mounting hole (311), the inserting hole (332) and the connecting holes (123) to connect the switch (31) and the engaging block (33) with the pivot panels (121) of the body (10).

The engaging recesses (334) are formed on the sidewall of the engaging block (33) and selectively engage the rib (214) of the lever (20) to hold the lever (20) on the engaging block (33).

The at least one resisting protrusion (335) is formed on and protrudes from the sidewall of the engaging block (33) opposite to the rib (214) of the lever (20) and selectively abuts the pivot segment (12) of the body (10) near the mounting bracket (11) to prevent the engaging recess (334) separating from the rib (214) of the lever (20) during accidental operation of the switch (31).

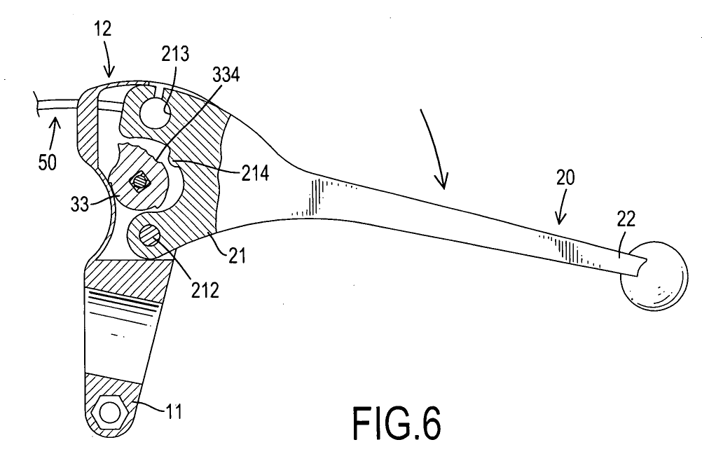

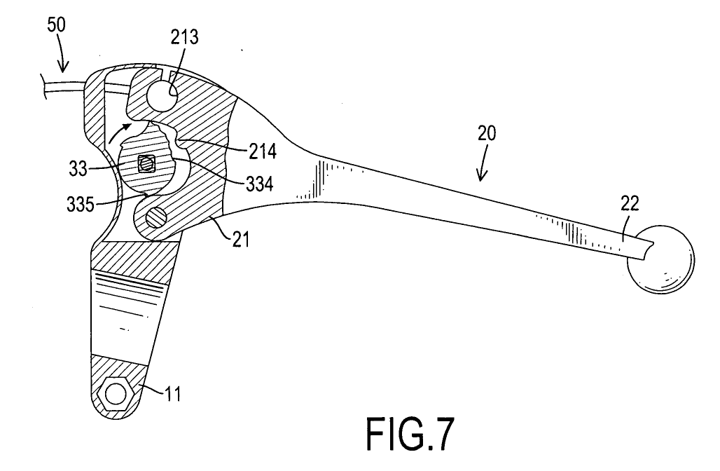

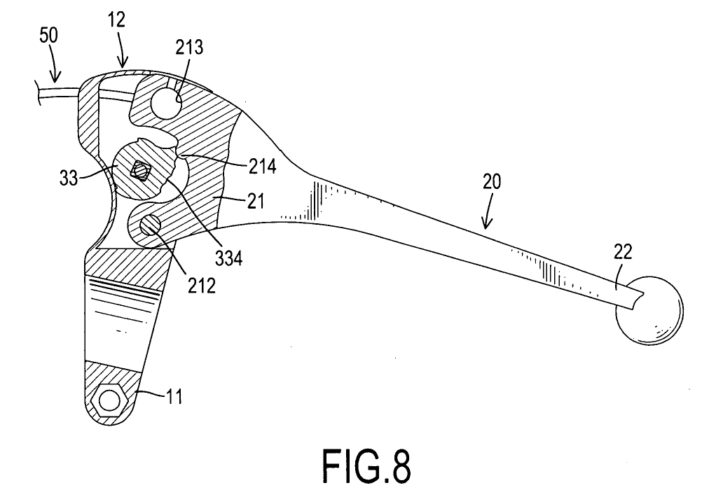

With further reference to FIGS. 6 to 8, when the user wants to adjust the included angle between the lever (20) and the handlebar (40), he can press the lever arm (22) of the lever (20) toward the handlebar (40) to make the rib (214) separate from a corresponding engaging recess (334) of the engaging block (33). Then, the user can rotate the switch (31) relative to the pivot segment (12) of the body (10) to make the engaging block (33) rotating relative to the rib (214) of the lever (20).

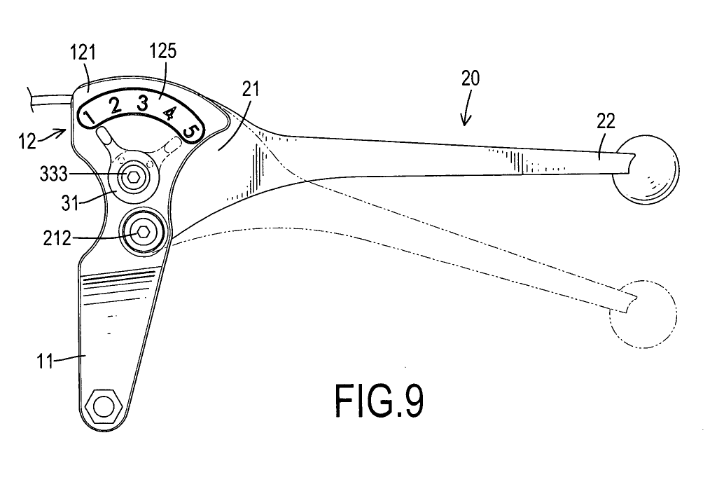

When the switch (31) is in place and is held on the corresponding pivot panel (121) by the ball (322) of the positioning element (32) engaging a corresponding detent (124), the user can remove the hand from the lever arm (22) of the lever (20) allowing the pivot end (21) of the lever (20) to rotate relative to the pivot segment (12) of the body (10) by a returning force of the brake cable (52) and the rib (214) of the lever (20) will engage a different engaging recess (334) in the engaging block (33). Since the rib (214) engages the different engaging recess (334) in the engaging block (33), the included angle between the lever (20) and the handlebar (40) can be adjusted as shown in FIG. 9.

Therefore, the bicycle brake lever in accordance with the present invention allows adjustment of the included angle between the lever (20) and the handlebar (40) to match different users being children or people with small hands, ensure the brake lever is operated easily to prevent traffic accidents. Furthermore, the user can lock the brake on by adjusting the adjusting device (30) to make the lever (20) close to the handlebar (40) when traveling downhill to slow the bicycle conveniently.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A bicycle brake lever being implemented on a bicycle and having
a body being adapted to be mounted on a handlebar of the bicycle and having
a mounting end;
a connecting end;
a mounting bracket being defined in the mounting end of the body for mounting around the handlebar of the bicycle; and
a pivot segment being defined in the connecting end of the body, being formed with the mounting bracket and having
two pivot panels being formed with the body parallel to each other and each pivot panel having
a pivot hole being formed through the pivot panel near the mounting bracket and aligning with the other pivot hole; and
a connecting hole being formed through the pivot panel near the pivot hole opposite to the mounting bracket and aligning with the other connecting hole; and
multiple detents being formed through one of the pivot panels around the connecting hole in the pivot panel;
a lever being pivotally connected to the body and having
a pivot end being pivotally connected to the pivot segment of the body and having
an internal surface;
a through hole being formed through the pivot end and aligning with the pivot holes of the pivot panels;
a pivot pin being mounted in the pivot holes of the pivot panels and the through hole of the pivot end of the lever to connect the lever with the body;
a cable hole being formed through the pivot end of the lever opposite to the through hole between the pivot panels to connect with a brake cable of the bicycle; and
a rib being formed on and protruding from the internal surface of the pivot end of the lever between the through hole and the cable hole; and
a lever arm being formed on the pivot end; and
an adjusting device being connected to the body and engaging the lever and having
a switch being rotatably mounted on the pivot segment of the body and having
a bottom abutting the pivot panel having the detents;
a mounting hole being polygonal, being formed through the bottom of the switch and aligning with the connecting holes of the pivot panels; and
a mounting recess being formed in the bottom of the switch and selectively communicating with the detents;
a positioning element being mounted in the switch and engaging the pivot panel having the detents; and
an engaging block being connected to the switch between the pivot panels, engaging the pivot end of the lever and having
a top;
a sidewall;
a switch mount being formed on and protruding from the top of the engaging block, corresponding to and being mounted in the mounting hole of the switch via a corresponding one of the connecting holes;
an inserting hole being formed through the switch mount and the engaging block and aligning with the mounting hole of the switch and the connecting holes of the pivot panels;
a mounting shaft being mounted in the mounting hole, the inserting hole and the connecting holes to connect the switch and the engaging block with the pivot panels of the body; and
multiple engaging recesses being formed on the sidewall of the engaging block and selectively engaging the rib of the lever to hold the lever on the engaging block.

2. The bicycle brake lever as claimed in claim 1, wherein the positioning element has
a spring being mounted in the mounting recess of the switch; and
a ball being mounted in the mounting recess of the switch, selectively engaging the detents to hold the switch in place.

3. The bicycle brake lever as claimed in claim 2, wherein the engaging block further has at least one resisting protrusion being formed on and protruding from the sidewall of the engaging block opposite to the rib of the lever and selectively abutting the pivot segment of the body near the mounting bracket to prevent the engaging recess separating from the rib of the lever.

4. The bicycle brake lever as claimed in claim 3 wherein the pivot segment of the body further has an indicator board being formed on the pivot panel having the detents and radially aligning with the connecting hole in the pivot panel through the detents.

5. The bicycle brake lever as claimed in claim 4, wherein the detents are formed through the pivot panel in an arc around the connecting hole.

6. The bicycle brake lever as claimed in claim 1 wherein the pivot segment of the body further has an indicator board being formed on the pivot panel having the detents and radially aligning with the connecting hole in the pivot panel through the detents.

7. The bicycle brake lever as claimed in claim 6, wherein the detents are formed in an arc around the connecting hole in the pivot panel in which the detents are defined.

8. The bicycle brake lever as claimed in claim 1, wherein the detents are formed through the pivot panels in an arc around the connecting hole in the pivot panel in which the detents are defined.

9. The bicycle brake lever as claimed in claim 1, wherein the engaging block further has at least one resisting protrusion being formed on and protruding from the sidewall of the engaging block opposite to the rib of the lever and selectively abutting the pivot segment of the body near the mounting bracket to prevent the engaging recess separating from the rib of the lever.
